(19) United States
(12) Patent Application Publication
(10) Pub. No.: US 2002/0174035 A1
(43) Pub. Date: Nov. 21, 2002

(54) Method and apparatus for placing an item for sale

(76) Inventors: Edith H. Stern, Yorktown Heights, NY (US); David P. Greene, Ossining, NY (US); Philip Shi-Lung Yu, Chappaqua, NY (US); Barry E. Willner, Briarcliff Manor, NY (US)

Correspondence Address: BUCKLEY, MASCHOFF, TALWALKAR, & ALLISON, 5 ELM STREET, NEW CANAAN, CT, 06840, US

(21) Appl. No.: 09/860,794

(22) Filed: May 18, 2001

(51) Int. Cl. G06F 17/60

(52) U.S. Cl. 705/27

(57) ABSTRACT

A system, method, apparatus, and computer program code for placing an item for sale includes providing an identification of an item that can be placed for sale along with an indication of a single action that can be performed for placing the item for sale. Upon receiving an indication of a completion of the single action, the item can be placed for sale in one or more designated marketplaces.

### FIELD OF THE INVENTION

The present invention relates to a method and apparatus for placing an item for sale and, more particularly, embodiments of the present invention relate to methods, apparatus, and computer program code for placing an item for sale using a single action.

### BACKGROUND OF THE INVENTION

People and businesses like to sell things. Fortunately, there are many different marketplaces places in which an owner of an item can place the item for sale. Conventional marketplaces include department stores, consignment shops, flea markets, pawnshops, etc. Marketplaces on the World Wide Web (the “Web”) include auction or reverse auction oriented Web sites such as Ebay (www.ebay.com), Amazon.com (www.amazon.com), Priceline (www.priceline.com) and Yahoo! (www.yahoo.com).

Unfortunately, placing an item for sale at a marketplace often takes time and effort along with a multitude of steps or tasks that must be completed. It would be advantageous to provide a method and apparatus that overcame the drawbacks of the prior art. In particular, it would be desirable to provide a method and apparatus for placing an item for sale that reduced the number of steps needed to place an item for sale at one or more marketplaces.

### SUMMARY OF THE INVENTION

Embodiments of the present invention provide a system, method, apparatus, and computer program code for facilitating the placement of an item for sale at one or more marketplaces. According to embodiments of the present invention, a single action may be used to place the item for sale in one or more marketplaces.

Additional objects, advantages, and novel features of the invention shall be set forth in part in the description that follows, and in part will become apparent to those skilled in the art upon examination of the following or may be learned by the practice of the invention.

According to one embodiment of the present invention, a method for placing an item for sale includes providing an indication of an item that can be placed for sale; providing an indication of a single action that can be performed to place the item for sale; receiving an indication of a completion of the single action; and optionally providing a notification of a placement of the item for sale. In other embodiments, a method of placing an item for sale includes providing information identifying an item that can be placed for sale; providing an indication of a single action that can be performed to place the item for sale; and, in response to only the single action, providing to a device associated with a marketplace for the item an indication that the item can be placed for sale. In other embodiments, a method for placing an item for sale includes identifying an item to be placed for sale; identifying a single action, completion of which will place the item for sale; completing the single action; and optionally receiving a notification of a placement of the item for sale.

According to other embodiments of the present invention, a system for assisting in sale of an item includes a memory; a communication port; and a processor connected to the memory and the communication port, the processor being operative to: provide an indication of an item that can be placed for sale; provide an indication of a single action that can be performed to place the item for sale; receive an indication of a completion of the single action; and optionally provide a notification of a placement of the item for sale. In other embodiments similar systems can be used to implement the methods described above. In still other embodiments, an apparatus for assisting in sale of an item includes means for sending an indication of an item that can be placed for sale; means for sending an indication of a single action that can be performed to place the item for sale; and means for obtaining an indication of a completion of the single action; and optional means for sending a notification of a placement of the item for sale. In other embodiments, a similar apparatus may be used to perform the methods described above.

According to still further embodiments of the present invention, a computer program product in a computer readable medium for placing an item for sale includes first instructions for indicating an item that can be placed for sale; second instructions for indicating an indication of a single action that can be performed to place the item for sale; third instructions for obtaining a notification of a completion of the single action; and optional fourth instructions for sending a notification of a placement of the item for sale.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a flowchart of a third embodiment of a method in accordance with the present invention;

FIG. 4 is a block diagram of system components for an embodiment of an apparatus usable with the methods of FIGS. 1-3;

FIG. 5 is a block diagram of a representative server of FIG. 4;

FIG. 6 is an illustration of a representative item information database of FIG. 5;

FIG. 7 is an illustration of a representative marketplace information database of FIG. 5; and

FIG. 8 is an illustration of a representative user information database of FIG. 5.

### DETAILED DESCRIPTION

Applicants have recognized that there is a need for systems and methods, which allow a user to quickly and easily place on item for sale at one or more marketplaces. In addition, applicants have recognized that there is a need to provide the ability for placing an item for sale at one or more marketplaces via the completion of a single action. A marketplace might be or include a department store, consignment shop, flea market, pawnshop, etc. Marketplaces on the World Wide Web (the “Web”) include auction or reverse auction oriented Web sites such as Ebay (www.ebay.com), Amazon.com (www.amazon.com), Priceline (www.priceline.com) and Yahoo! (www.yahoo.com). Marketplaces can be or include a seller-side marketplaces, buyer-side marketplaces, two-sided market places, private or public exchanges, clearinghouses, auctions, and bulletin boards. In some embodiments, a marketplace might be or include a spot market, commodities market, options market, or futures market. In other embodiments, a marketplace might be or include an exchange or any organization, association or group that provides or maintains a marketplace where securities, options, futures, or commodities can be traded or sold.

Embodiments of the present invention provide such capabilities, by providing an identification of an item that can be placed for sale along with an indication of a single action that can be performed for placing the item for sale. In some embodiments, upon receiving an indication of a completion of the single action, a notification will be sent that causes the identified item to be placed for sale in one or more marketplaces. These and other features will be discussed in further detail below, by describing a system, individual devices, and processes according to embodiments of the invention.

As one example of an implementation of a method in accordance with the present invention, a store manager might receive an inventory list of items available or potentially available for sale by the store via the store's Web site. The list might be sent to, and displayed on, a portable computer, smart telephone or personal digital assistant (e.g., a Palm VII™ device) carried or used by the store manager. By simply tapping on the name of an item on the displayed list, the item is automatically placed for sale on the store's Web site.

As another example, the store manager might walk through a warehouse containing items that can be placed for sale. Each item might include a tag that identifies the item and which might include information describing the item, its length of time in inventory, expiration date, etc. By simply scanning the identifier on the tag with a portable scanning device (e.g., a handheld computer equipped with a barcode scanner), the store manager can cause the item to be placed for sale automatically on the store's Web site.

As yet another example, a person who has a toy collection may have a distinct identifier located on each toy or on a printed or electronic list of the toys. By scanning or selecting the identifier associated with a particular toy, the toy is automatically placed for sale via auction on a Web site, such as the Web site found at www.ebay.com.

Process Description

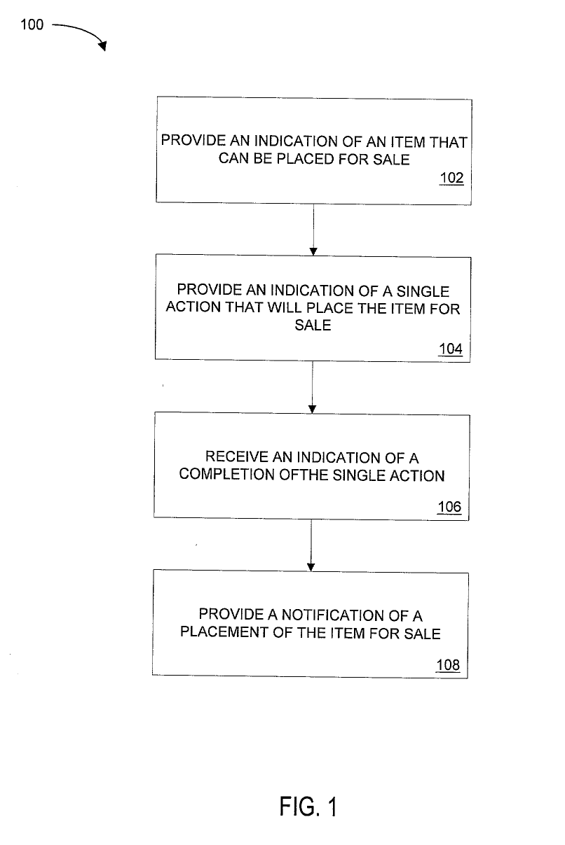

Reference is now made to FIG. 1, where a flow chart 100 is shown which represents the operation of an embodiment of a method of the present invention. The particular arrangement of elements in the method 100 is not meant to imply a fixed order to the steps; embodiments of the present invention can be practiced in any order that is practicable. In some embodiments, some or all of the steps of the method 100 may be performed or completed by a server, user device and/or another device, as will be discussed in more detail below.

Processing begins at a step 100 during which an indication or notification is provided of one or more items that can be placed for sale. There are many ways in which such an indication can be provided during the step 102. For example, a server hosting a Web site may send or download a list of items to one or more user devices (e.g., a personal digital assistant, computer). As another example, a server that stores or has access to item information may provide a listing of such items on a Web site. The Web site may be accessible by individuals or company representatives to see what items such individuals or companies have available to sell. In a third example, a server that manages or watches over inventory for a store may provide the store's manager or other employee with a list via email, XML (Extensible Markup Language) feed, instant message communication, HTTP (Hypertext Transfer Protocol), HTML (Hypertext Markup Language or FTP (File Transfer Protocol) transmission, or voicemail message every day of excess items in inventory, items that may be getting close to their expiration date, items going out of season or style, items currently in high demand from consumers, items having a designated price, items having a price above some designated threshold, etc. As a fourth example, a user device, such as a personal digital assistant or other user device may display the indication to a user holding or carrying the personal digital assistant or other user device.

The indication sent during the step 102 may include information regarding the item. For example, the indication may include a description of the item, name of the item, information regarding a manufacturer or distributor of the item, price information, information regarding one or more marketplaces where the item can be sold or has been sold in the past, current supply and demand information regarding the item, inventory information, a code or other identifier associated with the item, an image of the item, conditions of sale associated with the item, delivery or shipping requirements or preferences associated with the item, current or former users of the item, former purchasers of the item, etc.

During a step 104, an indication is provided of a single action that will place an item indicated during the step 102 for sale. The indication provided during the step 104 may be part of the indication sent during the step 102 and the steps 102 and 104 may be combined or completed in opposite order. In addition, in some embodiments sending the indication during the step 104 will complete the step 102 as well.

There are many single actions that might be used and indicated during the step 104. For example, a single action may comprise one of the following: clicking a mouse button when a cursor is positioned over a designated area of an identifier (e.g., a name, image) associated with an item; clicking on a mouse button when a cursor is positioned over a designated area of a Web page; clicking on a mouse button when a cursor is positioned over a link displayed on a Web page; entering or selecting a designated URL (uniform resource locator) via browser software operating on a user device; selecting a specific channel using a television remote control; contacting a specific portion of a touchscreen; calling or dialing a specific telephone number; accessing a specific device; making a specific command using a television remote control; detecting a presence of an item; determining or detecting a characteristic (which may be unique) of the item; depressing a designated key on a key pad; providing a designated audible signal; moving an item indicated during the step 102 within a designated proximity of another item; moving an item indicated during the step 102 to a designated location; moving an item indicated during the step 102 within range of a device capable of detecting a presence of the item; scanning a code (e.g., a barcode), identifier, text, or image associated with an item; navigating to a designated Web page; entering a designated code; making a designated sound; selecting using a pointing device; moving a cursor over a designated area of an identifier associated with an item indicated during the step 102, etc.

The indication provided during the step 104 may be provided in a variety of ways. For example, the indication provided during the step 104 may be part of or sent along with the indication provided during the step 102. As another example, the indication provided during the step 104 may done via information, images, etc. displayed on a Web site, kiosk, computer or other device. Alternatively, an indication of a single action may be communicated via wireless transmission or email message from a server to a user device (e.g., a personal digital assistant). The step 104 may be performed by the same device that performed the step 102 or a device different from the device that performed the step 102. A user device, such as a personal digital assistant or other user device may display the indication to a user holding the personal digital assistant or other user device. The indication sent during the step 104 may include information regarding the item. For example, the indication may include a description of the item, name of the item, information regarding a manufacturer or distributor of the item, price information, information regarding volume of a product under consideration, information regarding one or more marketplaces where the item can be placed for sale, sold or has been placed for sale or sold in the past, current supply and demand information regarding the item, inventory information, a code or other identifier associated with the item, an image of the item, conditions of sale associated with the item, delivery or shipping requirements or preferences associated with the item, current or former users of the item, former purchasers of the item, etc.

During a step 106, an indication is received of a completion or initiation of the single action indicated during the step 104. The step 106 may be performed in a variety of ways. For example, a server or other device that sent one or both of the indications during the steps 102 and 104 may receive the indication provided during the step 106 as part of an email message, instant message communication, XML feed, HTTP request or transmission, Web page request, wireless signal, etc. The server may operate a Web site that sends and receives such indications. In some embodiments, a device that completes the step 106 may be different from a device that completes the step 102 and/or a device that completes the step 104.

In some embodiments, the steps 102, 104 and/or 106 may be performed by a user device, such as a computer or personal digital assistant. The user device receives the indication of a completion of the single action by detecting a key press, touch screen press, command entry, etc. on the user device. Thus, the step 106 may be completed by a device detecting a completion of the single action indicated during the step 104.

The indication received during the step 106 may include a variety of information such as, for example, a name of a marketplace where in item can be sold, directions on how to communicate the placement of the item for sale to one or more marketplace, etc.

During a step 108, a notification or other indication is provided of a placement of the item indicated during the step 102 for sale at one or more marketplaces. The notification may include information regarding or relating the item being placed for sale such as, for example, a code or other identifier for the item, item description, item name, item price, information regarding the completion of the single action, item history or provenance, seller name, seller name, seller address, seller history, conditions related to the sale of the item, availability, etc. In some embodiments, the step 108 may not be needed and, as a result, the step 108 can be considered optional in the method 100.

The notification provided during the step 108 may be sent directly to a marketplace or a device or entity operating, controlling, hosting, or managing a marketplace. In some embodiments, the notification may be sent in a specific format designated or required by the device receiving the notification. For example, if the notification is sent to a marketplace to inform the marketplace that an item is to be, or can be, placed for sale at the marketplace, the marketplace may require that the notification be in a particular format or sent via a particular communication method or channel. One marketplace may require that the notification sent during the step 108 be in the form of an email message or instant message communication sent to a particular email address or instant messaging transmission while another may require that the email be in the form of an XML feed or transmission or FTP download or transmission to a specific URL (uniform resource locator). A different marketplace may require that the notification be sent as part of a Web page request or download. In some embodiments, the indication sent during the step 108 may need to include designated information and/or be sent in a specific format via specific communications channel to a specific email address, voicemail address, URL, Web site, physical location or address, etc.

In some embodiments, information regarding where, when and under what conditions an item can be placed for sale or sold might be received from a third party or third party device. For example, an adaptive or learning system might monitor the supply and demand and/or historical selling performance and behavior for certain items in one or more marketplaces and send a message to a store manager indicating a good time to sell a particular item that the store has in inventory. The message also might include a suggested price, a suggested number of items to place for sale, a suggested marketplace to sell the item(s), etc.

In some embodiments, a server or other device implementing the method 100 may participate in a negotiation regarding sale of the item indicated during the step 102. The server or other device may participate in the negotiation in accordance with rules established for the server, the item, the marketplace in which the item is being placed for sale or sold, another party or device (e.g., a party or device attempting to purchase the item), etc. For example, established rules might dictate a maximum or minimum price, delivery instructions or requirements, availability date, the negotiation strategy, etc.

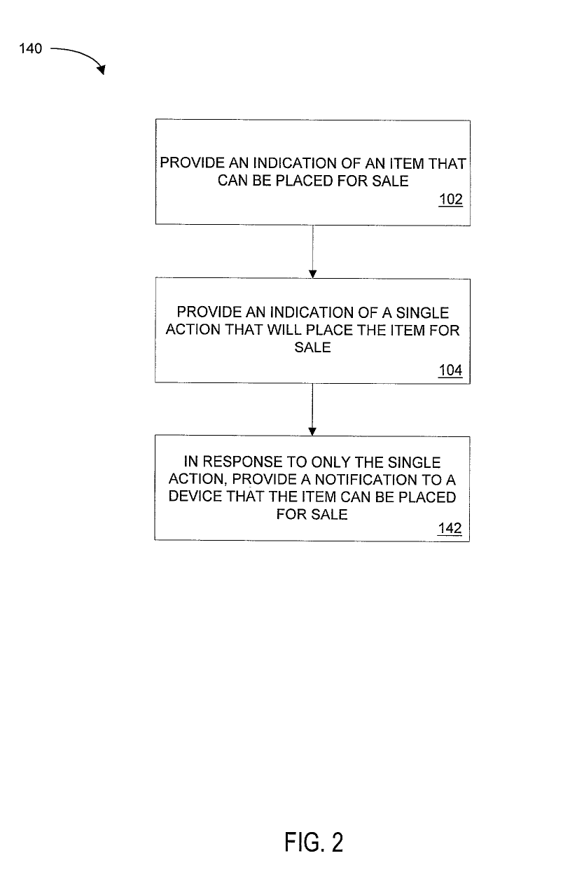

Reference is now made to FIG. 2, where a flow chart 140 is shown which represents the operation of an embodiment of a method of the present invention. The particular arrangement of elements in the method 140 is not meant to imply a fixed order to the steps; embodiments of the present invention can be practiced in any order that is practicable. In some embodiments, some or all of the steps of the method 140 may be performed or completed by a server, user device and/or another device, as will be discussed in more detail below.

The method 140 includes the steps 102 and 104 as previously described above. In addition, the method includes a step 142 during which a server, user device or other device, in response to only the single action indicated during the step 104, provides to a device a notification or other indication that the item is, or can be, placed for sale at a marketplace. The indication sent during the step 142 may be similar to the indication sent during the step 108 previously described above and may include designated information and/or be sent in a specific format via specific communications channel to a specific email address, voicemail address, URL, Web site, physical location or address, etc.

The method 140 is particularly applicable to implementation on a user device such as handheld or laptop computer or personal digital assistant. For example, a personal digital assistant, such as a Palm Vx™ device, may provide the indications during the steps 102 and 104 by displaying the appropriate information on its screen or display. As with the method 100, in some embodiments sending a single message may complete both of the steps 102 and 104. The information regarding the items available for sale may be downloaded to the user device from a computer. Alternatively, a barcode or other scanner attached to the user device may allow the user device to scan labels of items in a warehouse, storage area, inventory list, etc. that are available for sale. A farmer could use such a device to scan barcode labels or identification tags attached to livestock the farmer determines are ready for sale as the farmer walks among the livestock in a barn or field. A company employee could do a similar thing by walking through a warehouse and scanning labels or images on items located in the warehouse. In some embodiments, the user device might detect a sound, odor, texture, taste, chemical composition, etc. associated with an item for purposes of identifying the item. In other embodiments, the user device may include an antenna that can receive or detect signals emitted by items or a sonar or radar type capability to detect, located and/or identify items.

Once items are identified that are available for placement for sale, the user device may access an item information database to obtain additional information about the item, such as its expiration date, retail price, wholesale price, availability, etc. prior to completing the steps 102 and 104. Alternatively, such information may be included as part of the information coded within the barcode labels scanned by the user device.

After the user device completes the steps 102, and 104, the user device awaits the completion of the single action indicated during the step 104 for an item and sends a notification of the placement of an item for sale in response to the completion of the single action. For a personal digital assistant acting as the user device, the single action might be tapping with a stylus on an image or identifier of the item on the user device's screen, entering a designated character, etc.

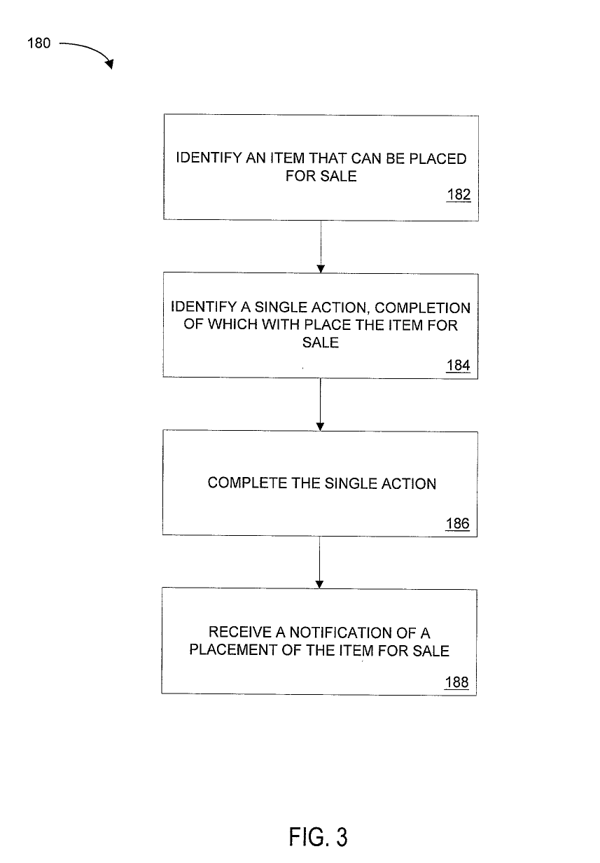

Reference is now made to FIG. 3, where a flow chart 180 is shown which represents the operation of an embodiment of a method of the present invention. The particular arrangement of elements in the method 180 is not meant to imply a fixed order to the steps; embodiments of the present invention can be practiced in any order that is practicable. In some embodiments, some or all of the steps of the method 180 may be performed or completed by a server, user device and/or another device, as will be discussed in more detail below.

The method 180 includes a step 182 during which a device, such as a user device, identifies one or more items to be placed for sale. An item can be identified in many ways, such as by scanning or receiving a code or other identifier associated with the item, receiving a list of potential of available items for sale from another device, accessing a database of items, receiving a message or other indication regarding the item, etc.

During a step 184, a single action is identified, completion of which will place the item identified during the step 182 for sale. A single action can be identified in many ways. For example, information regarding a single action might be displayed on a screen of a user device, provided by audible signal, communicated in a message regarding the item, etc. In some embodiments, the display of an icon or other image associated with an item on a user device or other device may by implication indicate that the single action associated with the item is selecting, opening, tapping on, or clicking on the icon or other image, moving the icon or other image to a designated part of the display, etc. In some embodiments, the steps 182 and 184 will be completed simultaneously.

During a step 186, the single action identified during the step 184 is completed. As a result, the item identified during the step 182 is automatically placed for sale in one or more marketplaces. In some embodiments, the method 180 may include a step of sending a notification of a completion of the single action.

During a step 188, a notification is received that indicates that the item identified during the step 182 has been placed for sale. The notification received during the step 188 may be received from a device associated with a marketplace (e.g., a server). For example, in some embodiments a user may user a personal digital assistant to identify items that can be placed for sale by scanning identifiers associated with the items. The user also may use the personal digital assistant to identify a single action that will place an item for sale in a marketplace. After the user completes the single action, the user may receive a notification that the item has been placed for sale in the designated marketplace.

The notification provided during the step 188 may include designated information and/or be sent in a specific format via specific communications channel to a specific email address, voicemail address, URL, Web site, physical location or address, etc. The step 188 is optional and may not be used in some embodiments of the method 180.

System

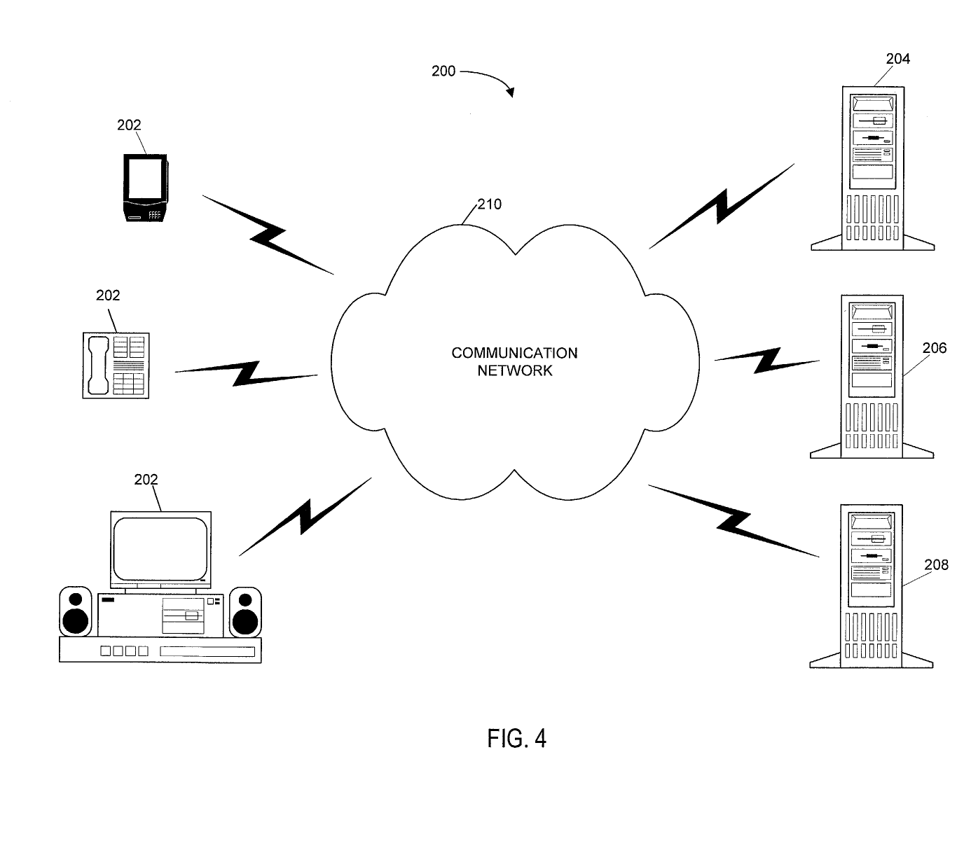

Now referring to FIG. 4, an apparatus or system 200 usable with the methods 100 and 150 is illustrated. The apparatus 200 includes one or more user devices 202 that may communicate directly or indirectly with one or more servers, controllers or other devices 204, 206, 208 via a computer, data, or communications network 210. For purposes of further explanation and elaboration of the methods 100 and 150, the methods 100, 140, 180 will be assumed to be operating on, or under the control of, one the servers or user devices.

A server may implement or host a Web site and/or be associated with a marketplace. Different servers may be associated with different marketplaces. For example, the server 204 may be associated with the auction oriented Web site Ebay (www.ebay.com) while the server 206 may be associated with a consignment store or coop and the server 208 with cattle or agricultural market.

A server can comprise a single device or computer, a networked set or group of devices or computers, a workstation, etc. In some embodiments, a server also may function as a database server and/or as a user device. The use, configuration and operation of servers will be discussed in more detail below.

The user devices 202 preferably allow entities to interact with one or more of the servers 204, 206, 208 and the remainder of the apparatus 200. The user devices 202 also may enable an entity to access Web sites, software, databases, marketplaces, etc. hosted, controlled, managed or operated by the servers 204, 206, 208. If desired, the user devices 202 also may be connected to or otherwise in communication with other devices. Possible user devices include a personal computer, portable computer, mobile or fixed user station, workstation, network terminal or server, smart telephone, cellular telephone, kiosk, dumb terminal, personal digital assistant, two-way pager, radio, etc.

Many different types of implementations or hardware configurations can be used in the system 200 and with the methods 100, 140, 180 and the methods disclosed herein are not limited to any specific hardware configuration for the system 200 or any of its components.

The communications network 210 might be or include the Internet, the World Wide Web, or some other public or private computer, cable, telephone or communications network or intranet, as will be described in further detail below. The communications network 210 illustrated in FIG. 4 is only meant to be generally representative of cable, computer, telephone or other communication networks for purposes of elaboration and explanation of the present invention and other devices, networks, etc. may be connected to the communications network 210 without departing from the scope of the present invention. The communications network 210 can also include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server, such as the server 204, without departing from the scope of the present invention. Moreover, as used herein, communications include those enabled by wired or wireless technology.

In some embodiments, a suitable wireless communication network 210 may include the use of Bluetooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 4 may be equipped with a microchip transceiver that transmits and receives in a previously unused frequency band of 2.45 GHz that is available globally (with some variation of bandwidth in different countries). Connections can be point-to-point or multipoint over a current maximum range of ten (10) meters. Embodiments using Bluetooth technology may require the additional use of one or more receiving stations to receive and forward data from individual user devices 202 or servers 204.

Although three user devices 202 and three servers 204, 206, 208 are shown in FIG. 4, any number of such devices may be included in the system 200. The devices shown in FIG. 4 need not be in constant communication. For example, a user device may communicate with a server only when such communication is appropriate or necessary.

Server

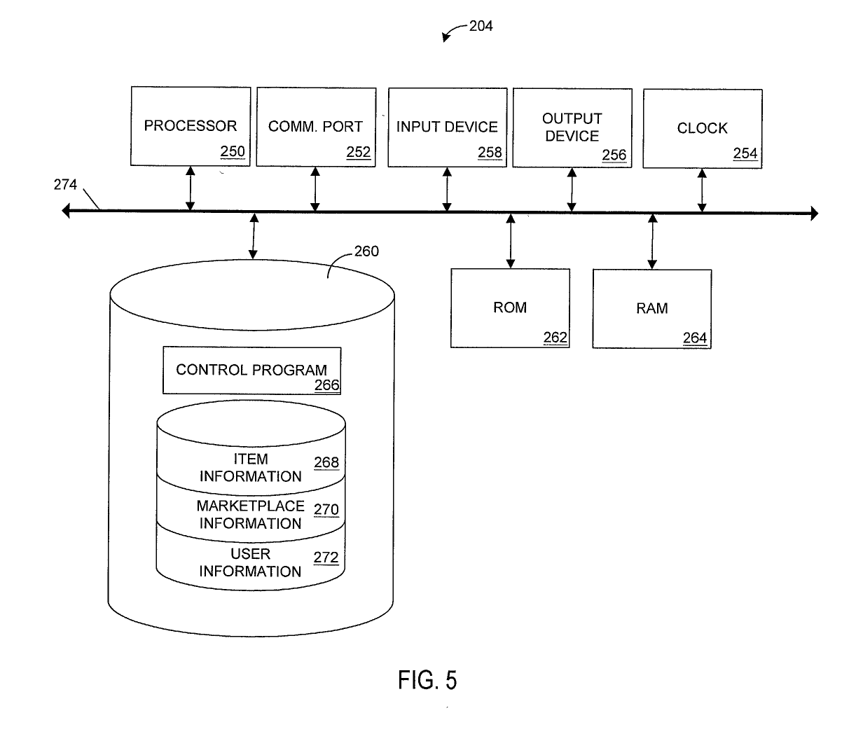

Now referring to FIG. 5, a representative block diagram of a server or controller, such as the server 204, is illustrated. The server 204 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The server 204 also may include an internal clock element 254 to maintain an accurate time and date for the server 204, create time stamps for communications received or sent by the server 204, etc.

If desired, the server 204 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 204 may include a memory or data storage device 260 to store information, software, databases, communications, entity information, attention unit information, device drivers, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, DVD drive, a compact disc and/or a hard disk. The server 204 also may include ROM 262 and RAM 264.

The processor 250 and the data storage device 260 in the server 204 each may be, for example: (i) located entirely within a single computer or other computing device; or (ii) connected to each other by a remote communication medium, such as a serial port cable, telephone line or radio frequency transceiver. In one embodiment, the server 204 may comprise one or more computers that are connected to a remote server computer for maintaining databases.

A conventional personal computer or workstation with sufficient memory and processing capability may be used as the server 204. In one embodiment, the server 204 operates as or includes a Web server for an Internet environment. The server 204 preferably is capable of high volume transaction processing, performing a significant number of mathematical calculations in processing communications and database searches. A Pentium™ microprocessor such as the Pentium III™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the server 204. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The server 204 also may include or store information regarding users, items, marketplaces, sales conditions or rules, etc. For example, information regarding items may be stored in an item information database 268 for use by the server 204 or another device or entity. Similarly, information regarding marketplaces may be stored in a marketplace information database 270 and information regarding users may be stored in a user information database 272 for use by the server 204 or another device or entity.

According to an embodiment of the present invention, the instructions of the control program may be read into a main memory from another computer-readable medium, such as from the ROM 262 to the RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 274.

While specific implementations and hardware configurations for servers 204 devices have been illustrated, it should be noted that other implementations and hardware configurations are possible and that no specific implementation or hardware configuration is needed. Thus, not all of the components illustrated in FIG. 5 may be needed for a server implementing the methods 100, 140, 180. Therefore, many different types of implementations or hardware configurations can be used in the system 200 and the methods disclosed herein are not limited to any specific hardware configuration.

User Device

As mentioned above, user device 202 may be or include any of a number of different types of devices, including, but not limited to a personal computer, portable computer, mobile or fixed user station, workstation, network terminal or server, telephone, beeper, kiosk, dumb terminal, personal digital assistant, smart telephone, cable set-top box, cash register, facsimile machine, two-way pager, radio, etc. If desired, the user device 202 also may function as a server 204. A user device 202 may be operated by or on behalf of any of a number of different entities that are interested in sending or receiving communications, item information, sale information, marketplace information, etc. In some embodiments, a user device 202 may have some or all of the same structure, configuration, and/or components as the server 204 illustrated in FIG. 5.

Databases

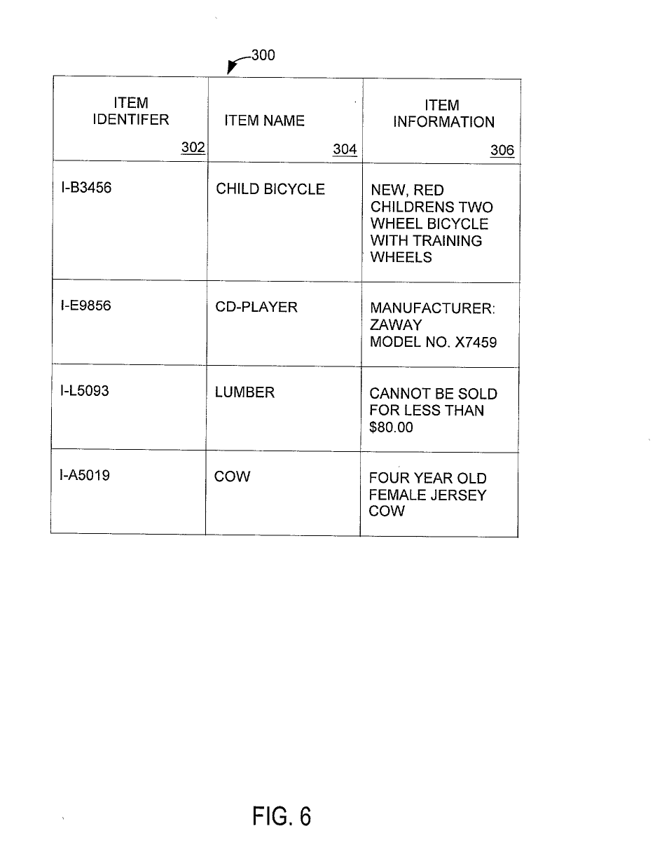

As previously discussed above, in some embodiments a server or user device can include or access an item information database 268 for storing or keeping information about one or more items placed for sale, sold, offered for sale, or available to be placed for sale. One representative item information database 300 is illustrated in FIG. 6.

The item information database 300 may include an item identifier field 302 that may include codes or other identifying information for items that have or may be placed for sale, an item name field 304 that may include names for items identified in the field 302, and an item information field 306 that may include descriptive, use, sale or other information related to the items identified in the field 302. For example, entries in the field 306 may describe price, delivery, availability, shipping and handling, and/or use of an item identified in the field 302. In some embodiments, an entry in the field 306 may describe conditions of sale for an item identified in the field 302, a minimum price that an item can be sold for, negotiation rules or guidelines, buyer requirements or characteristics (e.g., credit history, experience) desired, required or imposed by the seller of an item, etc. Other or different fields also may be used in the item information database 300.

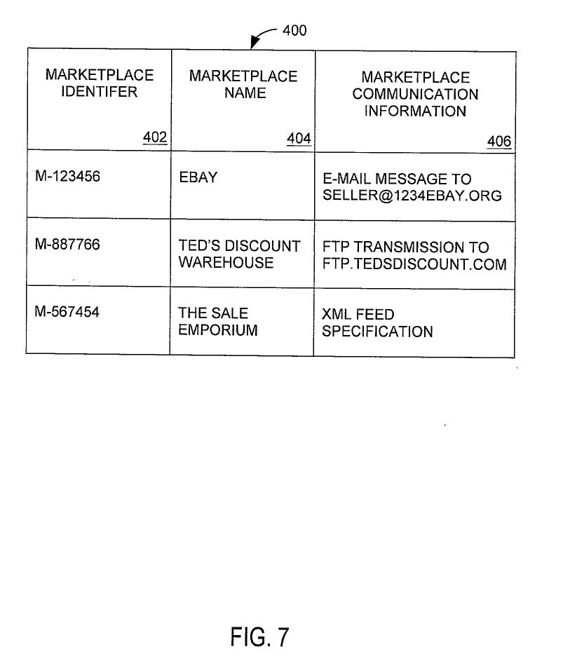

As previously discussed above, in some embodiments a server or user device may include a marketplace database 270 for storing or keeping information about one or more marketplaces where items can be sold. One representative marketplace information database 400 is illustrated in FIG. 7.

The marketplace information database 400 may include a marketplace identifier field 402 that may include codes or other identifying information for marketplaces where items have been sold, can be placed for sale or sold and/or are being sold, a marketplace name field 400 that may include names, addresses, or other descriptive information for the marketplaces identified in the field 402, and a marketplace communication information field 406 which may include information regarding how a notification of availability or placement of an item for sale can or should be communicated to the marketplaces identified in the field 402.

Other or different fields also may be used in the marketplace information 400. For example, the marketplace information database 400 may include fields including information regarding the Web site address, URL (uniform resource locator), or other addresses related to computers or one or more devices associated with or operating marketplaces

As illustrated in the marketplace information database 400, the marketplace identified as “M-123456” in the field 402 is associated with the “EBAY” auction Web site (www.ebay.com). A notification of a placement of an object for sale sent from a server, user device or other device to “EBAY” should be sent via email to the email address “SELLER@1234EBAY.ORG”, as indicated by the entry in the field 406 for the marketplace identified as “M-1234556” in the field 402.

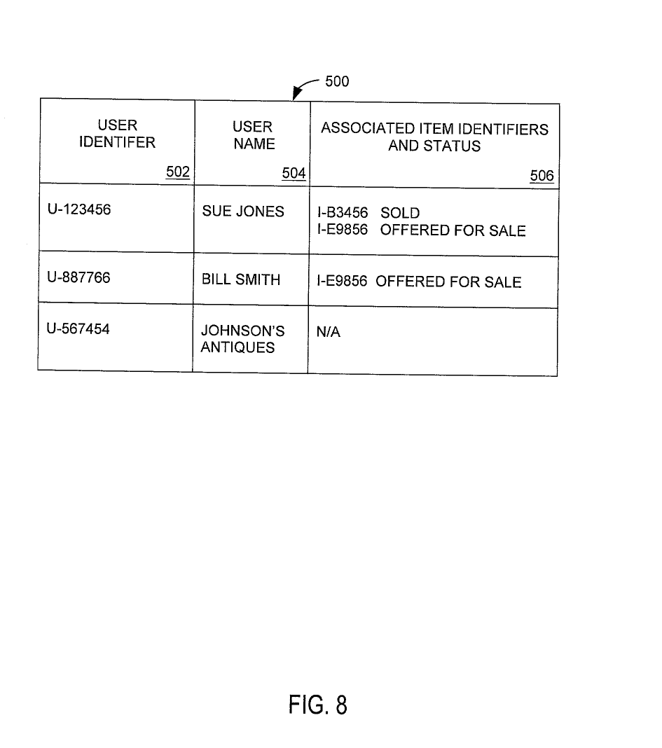

As previously discussed above, in some embodiments a server or user device may include a user information database 272 for storing or keeping information regarding one or more users that have items for sale, have sold items, have items available to offer for sale, etc. One representative user information database 500 is illustrated in FIG. 8.

The user information database 500 may include a user identifier field 502 that may include codes or other identifying information for users who have placed items for sale, can place items for sale, and/or are placing items for sale and a user name field 500 that may contain name, address, telephone, credit card, contact and/or other information for the users identified in the field 502. The user information database 500 also includes an associated item identifier and status field 506 that may include information regarding items placed for sale by the users identified in the field 502. Other or different fields also may be used in the user information 500.

As illustrated in the user information database 500, the user identified as “U-123456” in the field 502 is named “SUE JONES”. According to the entry in the field 506, the user “SUE JONES” has sold one item identified as “I-B3456” and has offered another item identified as “I-E9856” for sale. As illustrated by the item information database 300 illustrated in FIG. 6, the item identified as “I-B3456” in the field 560 is a “CHILD BICYCLE” and the item identified as “I-E9856” in the field 506 is a “CD-PLAYER”.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods 100, 140, 180 can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to a preferred embodiment thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for placing an item for sale, comprising:
providing an indication of an item that can be placed for sale;
providing an indication of a single action that can be performed to place said item for sale; and
receiving an indication of a completion of said single action.

2. The method of claim 1, further comprising:
providing a notification of a placement of said item for sale.

3. The method of claim 2, wherein said notification includes an identifier associated with said item.

4. The method of claim 1, wherein providing said notification of a placement of said item for sale includes providing said notification to a device.

5. The method of claim 4, wherein said device is associated with a marketplace.

6. The method of claim 1, further comprising:
receiving a notification that said item can be placed for sale.

7. The method of claim 6, wherein said providing an indication of a single action that can be performed to place said item for sale includes at least one of the following:
providing information identifying a marketplace where said item will be sold;
providing an indication of a delivery requirement associated with said item; and
providing an indication of a sale fulfillment requirement associated with said item.

8. The method of claim 1, wherein said single action is one of the following:
clicking a mouse button when a cursor is positioned over a designated area of an identifier associated with said item;
clicking on a mouse button when a cursor is positioned over a designated area of a Web page;
clicking on a mouse button when a cursor is positioned over a link displayed on a Web page; and
selecting a designated URL.

9. The method of claim 1, wherein said single action is one of the following:
selecting a specific channel using a television remote control;
making a specific command using a television remote control;
contacting a specific portion of a touchscreen;
calling a specific telephone number;
detecting a presence of said item;
determining a characteristic of said item;
detecting a unique identifying characteristic of said item;
depressing of a key on a key pad;
providing a designated signal;
moving said item within a designated proximity of another item;
moving said item to a designated location; and
moving said item within range of a device capable of detecting a presence of said item.

10. The method of claim 1, wherein said single action is one of the following:
scanning a code associated with said item;
scanning an image associated with said item;
navigating to a designated Web page;
entering a designated code;
making an designated sound;
selecting using a pointing device; and
moving a cursor over a designated area of an identifier associated with said item.

11. The method of claim 1, wherein said providing an indication of item includes at least one of the following:
serving a Web page that includes said indication;
causing said indication to be displayed on a Web page;
causing said indication to be displayed on a device associated with said item;
sending said indication to a device associated with said item;
causing said indication to be displayed on a television; and
causing said indication to be displayed on a user device.

12. The method of claim 1, wherein said indication of an item includes at least one of the following:
information describing said item;
an image of said item;
a code associated with said item;
an identifier associated with said item;
information regarding at least one negotiation rule associated with said item;
information regarding at least one negotiation rule associated with a designated marketplace;
information regarding at least one price associated with said item;
information regarding at least one condition of sale associated with said item;
information regarding at least one delivery requirement associated with said item;
information regarding at least one sale fulfillment requirement associated with said item;
inventory information for said item;
information regarding availability of said item; and
information regarding at least one marketplace where said item can be sold.

13. The method of claim 1, wherein said providing an indication of a single action that can be performed to place said item for sale includes at least one of the following:
providing an indication of how said item can be selected; and
providing an image of said item.

14. The method of claim 1, further comprising:
conducting a sale of said item.

15. The method of claim 1, further comprising:
facilitating a negotiation for sale of said item.

16. The method of claim 1, further comprising:
establishing at least one rule regarding how said negotiation may be conducted.

17. The method of claim 16, wherein said at least one rule includes at least one of the following:
establishing a maximum price for said item;
establishing a minimum price for said item;
establishing delivery instructions for said item;
establishing at least one delivery requirement for said item;
establishing at least one fulfillment requirement for said item; and
establishing at least one channel of communication for said negotiation.

18. The method of claim 1, further comprising,
determining said item to be placed for sale prior to said providing an indication of an item that can be placed for sale.

19. The method of claim 18, wherein said determining said item to be placed for sale includes receiving a notification that said item can be placed for sale.

20. The method of claim 1, further comprising:
receiving a notification that a sale of said item has been completed.

21. The method of claim 1, further comprising:
fulfilling a sale for said item.

22. The method of claim 1, further comprising:
selecting said item for placement for sale.

23. The method of claim 22, wherein said selecting said item for placement for sale includes at least one of the following:
receiving a notification that said item can be placed for sale;
selecting said product based, at least in part, on a characteristic of said item;
selecting said product based, at least in part, on a characteristic of a marketplace where said item can be sold;
selecting said item from a plurality of items based, at least in part, on a price associated with said item;
selecting said item from a plurality of items based, at least in part, on an inventory level associated with said item;
selecting said item from a plurality of items based, at least in part, on said item's perishability;
selecting said item from a plurality of items based, at least in part, on an expiration date associated with said item;
selecting said item from a plurality of items based, at least in part, on said item's current location;
selecting said item from a plurality of items based, at least in part, on said item's proximity to a designated location;
selecting said item from a plurality of items based, at least in part, on said item's proximity to a designated device;
selecting said item from a plurality of items based, at least in part, on said item's compatibility with another item;
selecting said item from a plurality of items based, at least in part, on said item's similarity with another item;
selecting said item from a plurality of items based, at least in part, on the occurrence of an event;
selecting said item from a plurality of items based, at least in part, on the occurrence of a specific time;
selecting said item from a plurality of items based, at least in part, on the occurrence of a specific date;
selecting said item from a plurality of items based, at least in part, on said item's selling history;
selecting said item from a plurality of items based, at least in part, on availability of a marketplace capable of selling said item;
selecting said item from a plurality of items based, at least in part, on estimated demand for said item; and
selecting said item from a plurality of items based, at least in part, on estimated future availability of said item.

24. The method of claim 1, further comprising:
receiving information associated with said item.

25. The method of claim 24, wherein said information includes at least one of the following:
information regarding a characteristic of said item;
information regarding a marketplace where said item can be sold;
information regarding a price associated with said item;
information regarding an inventory level associated with said item;
information regarding said item's sale history;
information regarding said item's perishability;
information regarding an expiration date associated with said item;
information regarding said item's proximity to a designated device;
information regarding said item's compatibility with another item;
information regarding said item's similarity with another item;
information regarding availability of a marketplace capable of selling said item;
information regarding estimated demand for said item; and
information regarding estimated future availability of said item.

26. The method of claim 1, further comprising:
receiving a notification that sale of said item is complete.

27. The method of claim 1, further comprising:
providing a notification that sale of said item is complete.

28. A method of placing an item for sale, comprising:
providing information identifying an item that can be placed for sale; and
providing an indication of a single action that can be performed to place said item for sale.

29. The method of claim 28, further comprising:
in response to only said single action, providing to a device an indication that said item can be placed for sale.

30. The method of claim 29, wherein said device is associated with a marketplace.

31. A method of placing an item for sale, comprising:
providing information identifying an item that can be placed for sale;
providing an indication of a single action that can be performed to place said item for sale; and
in response to only said single action, placing said item for sale.

32. A method for placing an item for sale, comprising:
identifying an item to be placed for sale;
identifying a single action, completion of which will place said item for sale; and
completing said single action.

33. The method of claim 31, further comprising:
receiving a notification of a placement of said item for sale.

34. A system for assisting in sale of an item, comprising:
a memory;
a communication port; and
a processor connected to said memory and said communication port, said processor being operative to:
provide an indication of an item that can be placed for sale;
provide an indication of a single action that can be performed to place said item for sale; and
receive an indication of a completion of said single action.

35. A computer program product in a computer readable medium for placing an item for sale, comprising:
first instructions for indicating an item that can be placed for sale;
second instructions for indicating an indication of a single action that can be performed to place said item for sale; and
third instructions for obtaining a notification of a completion of said single action.
